(19) United States
(12) Patent Application Publication
(10) Pub. No.: US 2004/0004675 A1
(43) Pub. Date: Jan. 8, 2004

(54) Image projection display apparatus

(75) Inventor: Kouichi Honda, Kanagawa-ken (JP)

Correspondence Address: PILLSBURY WINTHROP, LLP, P.O. BOX 10500, MCLEAN, VA, 22102, US

(73) Assignee: Toshiba Lighting & Technology Corporation, Tokyo (JP)

(21) Appl. No.: 10/612,046

(22) Filed: Jul. 3, 2003

(30) Foreign Application Priority Data
Jul. 5, 2002 (JP) P2002-196694

(51) Int. Cl. H04N 9/31

(52) U.S. Cl. 348/744; 348/771

(57) ABSTRACT

The invention provides an image projection display apparatus comprising an image signal source for providing primary color signals, a light source comprising light emitting devices respectively emitting monochromatic lights corresponding to the primary color signals, a first optical system for guiding the monochromatic lights, a DMD having two-dimensionally arrayed micro-mirrors, provided for receiving the monochromatic lights guided through first optical system, a controller receiving the primary color signals for controlling the DMD so that specific micro-mirrors on the DMD change their own orientations by being activated with the primary color signals sequentially supplied from the image signal source and the light source so that the respective monochromatic lights are sequentially emitted in synchronous with the primary color signals, and a second optical system for sequentially projecting respective primary color image patterns presented by the specific orientation-changed micro-mirrors on the DMD in a prescribed direction.

### CROSS-REFERENCE TO RELATED APPLICATIONS

This application is based upon and claims the benefit of priority from the prior Japanese Patent Applications JP2002-196694 filed on Jul. 5, 2002, the entire content of which is incorporated herein by reference.

### FIELD OF THE INVENTION

This invention relates to an image projection display apparatus provided with a digital micro-mirror device (hereinafter referred to as DMD).

### BACKGROUND OF THE INVENTION

A conventional image projection display apparatus (prior art I) is provided with a light source using a high-pressure discharge lamp, a color filter so called color wheel or color disc, a DMD, an optical system and an image signal source. The light source emits white-light. The white-light then enters the color filter. The color filter comprises one or more sets of circularly disposed red-light transmitting filters, green-light transmitting filters and blue-light transmitting filters. The color filter separates white-light into a red-light, a green-light and a blue-light in time-series by being rotated with a motor. Those separated monochromatic lights sequentially enter the DMD.

The DMD comprises a plurality of two-dimensionally arrayed micro-mirrors. Specific micro-mirrors of the DMD change their own orientations by being activated with respective primary color signals sequentially entering the DMD from the image signal source. Thereby, the respective monochromatic lights applied to the DMD are reflected from a group of the specific micro-mirrors to a projection lens of the optical system. Consequently, a color image is displayed on a projection surface.

The prior art I has a high using efficiency of light, while having few color aberrations caused by overlapping three primary colors. The prior art I is free from unevenness in each color, which is incident in a liquid crystal system image projection display apparatus. Further, the prior art I has an advantage of that it is easy to digitally control the color tones.

On the other hand, JP2000-194275-A (prior art II) discloses an image display apparatus comprising light emitting devices emitting red, green and blue lights such as red, green and blue light emitting diodes (hereinafter referred to as LEDs), three liquid crystal panels transmitting or reflecting red, green and blue lights, respectively, or a single liquid crystal panel sequentially transmitting or reflecting red, green and blue lights.

The prior art II has an advantage of that it needs little electricity to work.

However, the prior art I has a drawback of that it is complicated in its structure, thereby it is expensive in its cost and low in its reliability. The prior art I has another drawback of that the quantity of transmitting light is heavily decreased, thereby the brightness of the projected image is lowered. The prior art I has still another drawback of that there is a risk of fracturing the high-pressure discharge lamp constituting the light source. The prior art I has further drawback of that it requires require a measurable amount of power.

On the other hand, the prior art II has a drawback of that it is expensive in its cost because it varies a transmittance or a reflectance of liquid crystal panel. The prior art II has also a drawback of that a brightness of image projected is degraded since the quantity of projected light is heavily decreased.

### SUMMARY OF THE INVENTION

An object of the present invention is to provide a image projection display apparatus which is inexpensive in its cost, excellent in its reliability, superior in its using efficiency of light, few in color aberration incident in a color overlapping system, and easy to adjust a color balance of image.

To achieve the above object, an image projection display apparatus according to one aspect of the present invention comprises an image signal source providing two or more sorts of primary color signals, a light source comprising a plural sort of light emitting devices respectively emitting monochromatic lights corresponding to the primary color signals, a first optical system for guiding the monochromatic lights output from the light source, a digital micro-mirror device having a plurality of two-dimensionally arrayed micro-mirrors, provided for receiving the monochromatic lights, guided through first optical system, a controller receiving the primary color signals from the image signal source for controlling the digital micro-mirror device so that specific micro-mirrors on the digital micro-mirror device change their own orientations by being activated with the primary color signals sequentially supplied from the image signal source and the light source so that the respective monochromatic lights are sequentially emitted in synchronous with the primary color signals, and a second optical system for sequentially projecting respective primary color image patterns presented by the specific orientation-changed micro-mirrors on the digital micro-mirror device in a prescribed direction.

In the present invention and each invention described below, the terms are defined to have the following technical meanings, unless otherwise specified:

### Light Emitting Device

“Light emitting device” means a monochromatic light emitting means. As the light emitting device, it is able to use a light emitting diode, a laser diode, etc. Light emitting devices may be any of a red-light emitting devic, a green-light emitting device, a blue-light emitting device, etc., by light color.

The light emitting device can be used in combination with an adequate reflecting device, in order to enhance condensing efficiency. For example, the image projection display apparatus can take a configuration that the light emitting device is located on a focal point of a parabola reflector. Then, the light emitted from the light emitting device is condensed with the parabola reflector and then enters the condenser lens in an optical system. In this case, two or more light emitting devices with different light colors can be mounted together in one parabola reflector. Alternatively, the light emitting devices with different light colors can be separately mounted on separate reflectors. The light emitting device can be integrated with a minute reflector. In order to enter the light emitted from the light emitting device to the condenser lens of optical system at a grade of uniform brightness required for a screen, a plural set of different color light emitting devices can be mounted dispersively on a disc. According to the above configuration, the light source becomes possible to be flat-sized.

### Digital Micro-Mirror Device (DMD)

“DMD” is a device provided with a large number of two-dimensionally arrayed micro-mirrors. Each micro-mirror of the DMD is configured to change its orientation by being activated with an electric signal, for example, an image signal. Therefore, specific micro-mirrors changing their own orientations by being activated with an image signal supplied from a controller reflect the light applied thereto through an optical system in a prescribed direction.

### Controller

“Controller” is a device which controls the light emitting devices and the DMD in synchronous with each other. That is, the controller controls a plural sort of light emitting devices with different light colors to emit sequentially in synchronous with respective primary color signals of color image signal. The controller sequentially supplies respective primary color signals of color image signal to the DMD. Therefore, in response to the primary color signal supplied thereto, specific micro-mirrors are activated and change their own orientations. Consequently, respective primary color images presented by a group of the specific micro-mirrors; changing their own orientations are sequentially projected to a projection surface through the second optical system.

### First and Second Optical Systems

“First optical system” means an optical system for guiding the red, green and blue monochromatic lights emitted by the light emitting devices to the DMD. “Second optical system” means another optical system for guiding the red, green and blue monochromatic images sequentially presented on the DMD to the projection surface. The first optical system is basically constituted by using a condenser lens. The first optical system can comprise additional optical device, such as an optical integrator, a mirror or a prism for changing light path, if needed. The second optical system is basically constituted by using a projection lens. By the way, the second optical system can comprise additional optical device, such as a total internal reflection prism (hereinafter referred as TIR prism), if needed.

Now the operation of the image projection display apparatus according to the present invention will be described. Specific light emitting devices, e.g., the red-light emitting devices emit red-color light in synchronous with the red primary color signal of the color image signal under a control of the controller. The red-color light enters the DMD through the first optical system. At this time, the DMD is activated in response to the red primary color signal of the color image signal. Therefore, a group of specific micro-mirrors are activated by the red primary color signal so that taken from the second optical system a red-color image is presented on the DMD. Consequently, the red-color image presented on the DMD is projected to a screen through the second optical system.

Following the red-light emitting devices, the green-light emitting devices of the light source emit green-color light in synchronous with the green primary color signal of the color image signal under the control of the controller. The green-color light enters the DMD through the first optical system. At this time, the DMD is activated in response to the green primary color signal of the color image signal. Therefore, a group of specific micro-mirrors are activated by the green primary color signal so that taken from the second optical system a green-color image is presented on the DMD. Consequently, the green-color image presented on the DMD is projected to the screen through the second optical system.

Following the green-light emitting devices, the blue-light emitting devices of the light source emit blue-color light in synchronous with the blue primary color signal of the color image signal under the control of the controller. At this time, the DMD is activated in response to the blue primary color signal of the color image signal. Therefore, a group of specific micro-mirrors are activated by the blue primary color signal so that taken from the second optical system a blue-color image is presented on the DMD. Consequently, the blue-color image presented on the DMD is projected to the screen through the second optical system.

As described above, since the red-color image, the green-color image and the blue-color image are sequentially emitted from the light source in changing at a short time period, a color image by an additive color combination of the red-color image, the green-color image and the blue-color image, which is recognized by viewers as a color signal in the effect of after-image.

According to the above configuration, the image projection display apparatus according to the present invention has following features.

(1). Rotating color filter does not required. Accordingly, it is simple in structure, low in cost, and excellent in reliability.

(2). The red, green and blue monochromatic lights are individually controlled. Accordingly, it is easy to adjust the color balance of the projected color image. That is, it is able to easily adjust the color balance of the projected color image by is on which it is projected can be easily adjusted by controlling in a PWM manner the actuating power source of the red, green and blue light emitting devices.

(3). Unitary DMD is used for the red, green and blue monochromatic lights in a time-sharing manner. Accordingly, it is free from a color aberration incident in a color overlapping system.

An image projection display apparatus according to another aspect of the present invention is characterized by that the light source comprises one or more sets of a red-light emitting device, a green-light emitting device, and a blue-light emitting device as the plural sort of light emitting devices.

This aspect of the present invention specifies an image projection display apparatus using three color lights, i.e., red-light, green-light and blue-light as respective monochromatic lights suitable for achieving a color image by an additive color combination of the red-color image, the green-color image and the blue-color image, which is recognized by viewers as a color signal in the effect of after-image.

An image projection display apparatus according to still another aspect of the present invention is characterized by that the controller adjusts the quantities of respective emitted monochromatic lights by controlling the operation times of the respective light emitting device.

This aspect of the present invention specifies an image projection display apparatus suitable for adjusting a color balance and a brightness of projected color image.

That is, the color balance can be adjusted by relatively changing emission times of the respective monochromatic lights. While, the brightness of projected color image can be controlled by simaltaneously lengthening or shortening the emission times of respective monochromatic lights. By the way, the emission times of respective monochromatic lights can be lengthened or shortened by controlling in a PWM manner the actuating power source of the light emitting devices.

Additional objects and advantages of the present invention will be apparent to persons skilled in the art from a study of the following description and the accompanying drawings, which are hereby incorporated in and constitute a part of this specification.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a schematic diagram showing a first embodiment of the image projection display apparatus according to the present invention;

FIG. 2 is a front view of a light source; and

FIG. 3 is a schematic diagram showing a second embodiment of the image projection display apparatus according to the present invention.

### DESCRIPTION OF THE PREFERRED EMBODIMENTS

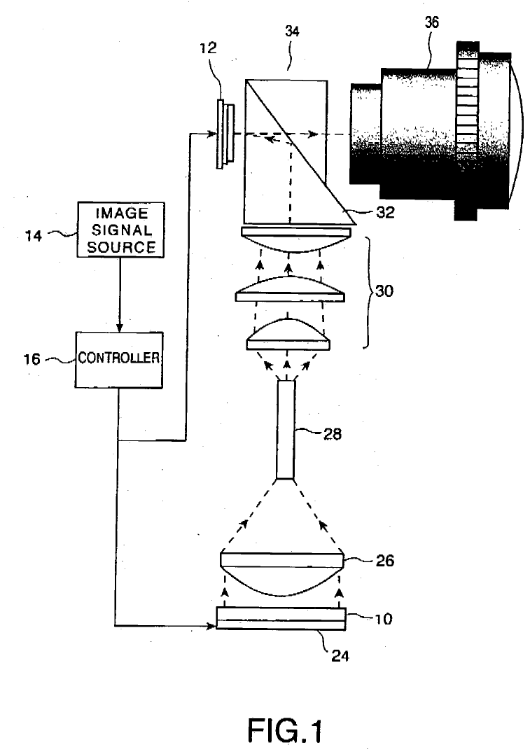

Referring now to the attached drawings FIGS. 1 through 3, preferred embodiments of the present invention will be explained hereinafter.

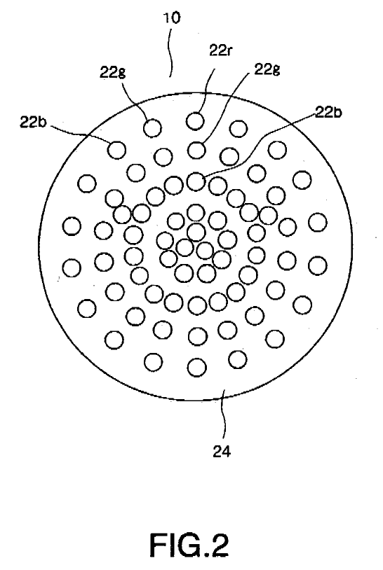

FIGS. 1 and 2 show a first embodiment of the image projection display apparatus according to the present invention. FIG. 1 is a schematic diagram of the first embodiment of the image projection display apparatus, while FIG. 2 is a front view of the light source shown in FIG. 1. The first embodiment of the image projection display apparatus comprises a light source 10, a DMD 12, an image signal source 14, a controller 16, a first optical system 18, and a second optical system 20.

As shown in FIG. 2, the light source 10 has an assembly of a plural set of red-light emitting diode 22r, green-light emitting diode 22g, and blue-light emitting diode 22b. In more detail, same number of the red-light emitting diodes 22r, the green-light emitting diodes 22g, and the blue-light emitting diodes 22b are mounted on a disc 24, in a manner that they are disposed thickly around the center of the disc 24, while roughly around the periphery of the disc 24. The red light emitting diode 22r, the green-light emitting diode 22g, and the blue-light emitting diode 22b are repeatedly disposed in that order both in the radius direction and the circumferential direction of the disc 24. Further, at the center of the disc 24, three of the red-light emitting diode 22r, the green-light emitting diode 22g, and the blue-light emitting diode 22b are located on the vertice of a triangle.

The DMD 12 is constituted in one-chip configuration of integrated-circuit semiconductor device comprising micro-mirrors in a number corresponding to number of pixels of one image, wherein each micro-mirror is able to be driven in synchronous with individual primary color signals of a color image signal.

The image signal source 14 can provide either a still image signal or a moving image signal. Therefore, the image projection display apparatus according to the first embodiment of the present invention can project to display either a television display image or a personal computer display image.

The controller 16 controls the red-light emitting diode 22r, the green-light emitting diode 22g, and the blue-light emitting diode 22b of the light source 10 to emit lights in synchronous with the red, green and blue primary color signals of the color image signal supplied to the DMD 12. That is, the red-light emitting diode 22r, the green-light emitting diode 22g, and the blue-light emitting diode 22b are interchangeably operated by color types to emit light sequentially in synchronous with the red, green and blue primary color signals. In addition, the DMD 12 is so controlled that specific micro-mirrors change their own orientations in response to the each primary color signal of the color image signal. Consequently, red, green and blue primary color images are sequentially presented on the DMD 12 by the specific micro-mirrors changing their own orientations, and then projected sequentially in that order on a screen (not shown) through the second optical system 20.

The first optical system 18 comprises a condenser lens 26, an optical integrator 28, a set of relay lenses 30, and a first TIR prism 32. The second optical system 20 comprises a second TIR prism 34 and a projection lens 36.

The controller 16 supplies each color signal of the color image signal supplied from the image signal source 14 to the DMD 12, and it controls luminescence of each light emitting device of a light source 10 in synchronous with each color signal. That is, the controller 16 activates, for example, the red-light emitting diode 22r in synchronous with the red primary color signal. When the red-light emitting diode 22r is activated, a red-light will be emitted from the light source 10. The red-light is condensed with the condenser lens 26 and then applied to the DMD 12 through the optical integrator 28, the relay lens 30, and the first TIR prism 32 of the first optical system 18. At this time, in the DMD 12, only a group of the specific micro-mirrors activated in corresponding to the red primary color signal change their own orientations. Therefore, a red-color image is presented on the DMD 12 which is seen from the second optical system. The red-color image is applied to the projection lens 36 through the first and second TIR prisms 32, 34. The projection lens 36 projects the red-color image to the screen, thereby the red-color image is displayed on the screen.

Following the display of the red-color image, the controller 16 activates the green-light emitting diode 22g in synchronous with the green primary color signal. When the green-light emitting diode 22g is activated, a green-light will be emitted from the light source 10. Incidence of the green-light is carried out to the DMD 12 like the time of red-light. The green-light is condensed with the condenser lens 26 and then applied to the DMD 12 through the optical integrator 28, the relay lens 30, and the first TIR prism 32 of the first optical system 18, like the red-light. At this time, in the DMD 12, only a group of the specific micro-mirrors activated in corresponding to the green primary color signal change their own orientations. Therefore, a green-color image is presented on the DMD 12 and then projected on the screen, like the red-color image being presented.

Following further the display of the green-color image, the controller 16 activates the blue-light emitting diode 22b in synchronous with the blue primary color signal. When the blue-light emitting diode 22b is activated, a blue-light will be emitted from the light source 10. Incidence of the blue-light is carried out to the DMD 12 like the time of red-light and green-light. The blue-light is condensed with the condenser lens 26 and then applied to the DMD 12 through the optical integrator 28, the relay lens 30, and the first TIR prism 32 of the first optical system 18, like the red-light and the green-light. At this time, in the DMD 12, only a group of the specific micro-mirrors activated in corresponding to the blue primary color signal change their own orientations. Therefore, a blue-color image is presented on the DMD 12 and then projected on the screen, like the red-color image and the green-color image being presented.

Since the red-color image, the green-color image, and the blue-color image are sequentially projected to the screen as mentioned above, a color image becomes visible to viewers.

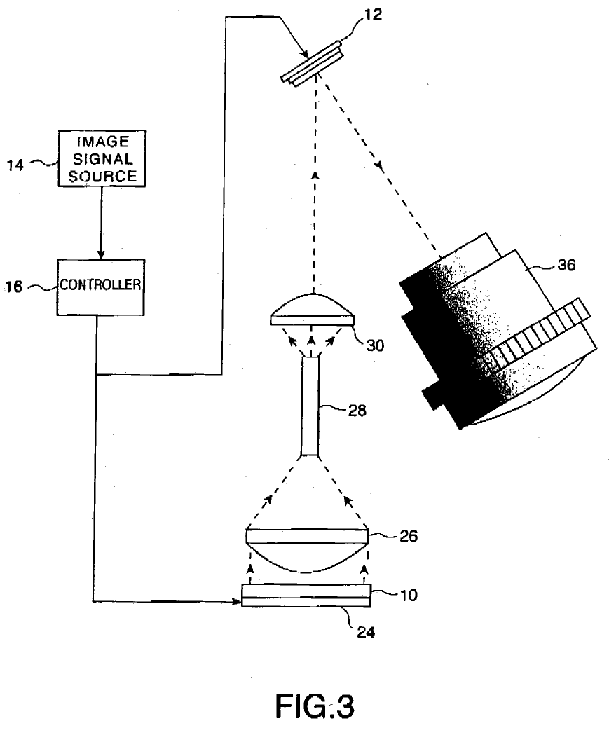

FIG. 3 is a schematic diagram showing the second embodiment of the image projection display apparatus according to the present invention. In FIG. 3, the same elements as those, as shown in FIG. 1, are assigned with the like reference numerals and not discussed herein. The second embodiment of the image projection display apparatus differs from the first embodiment of the image projection display apparatus in the configurations of the first and the second optical systems 18 and 20. That is, in the second embodiment of the image projection display apparatus the first and the second optical systems 18 and 20 are constituted without use of prisms such as the first and the second TIR prisms 32 and 34,

According to the first aspect of the present invention, it is characterized by that the image projection display apparatus comprises an image signal source providing two or more sorts of primary color signals, a light source comprising a plural sort of light emitting devices respectively emitting monochromatic lights corresponding to the primary color signals, a first optical system for guiding the monochromatic lights output from the light source, a digital micro-mirror device having a plurality of two-dimensionally arrayed micro-mirrors, provided for receiving the monochromatic lights guided through first optical system, a controller receiving the primary color signals from the image signal source for controlling the digital micro-mirror device so that specific micro-mirrors on the digital micro-mirror device change their own orientations by being activated with the primary color signals sequentially supplied from the image signal source and the light source so that the respective monochromatic lights are sequentially emitted in synchronous with the primary color signals, and a second optical system for sequentially projecting respective primary color image patterns presented by the specific orientation-changed micro-mirrors on the digital micro-mirror device in a prescribed direction.

Therefore, the first aspect of the present invention is able to provide By providing the second optical system which projects each primary color image expressed by each micro-mirror in which attitude control was carried out by the controller one by one in the predetermined direction from the DMD, structure is easy. The color aberration by superposition of monochromatic light does not occur on the color image on which it is low cost, and high reliability and the using efficiency of light are high, and it is projected, but the image projection display apparatus which is easy to adjust the color balance of a color image can be provided.

According to another aspect of the present invention, it is characterized by that, when the two or more light emitting devices are a red-light emitting device, a green-light emitting device, and a blue-light emitting device, the image projection display apparatus for which a color image is displayed by the additive color combination of the red, green and blue monochromatic color images sequentially projected from the DMD based on them can be provided.

According to still another aspect of the present invention, the controller can provide a suitable image projection display apparatus to adjust the color balance and the quantity of light of the color image on which it is projected by controlling the operation time of the light emitting device, and changing the quantity of emitted light.

While there have been illustrated and described what are at present considered to be preferred embodiments of the present invention, it will be understood by those skilled in the art that various changes and modifications may be made, and equivalents may be substituted for elements thereof without departing from the true scope of the present invention. In addition, many modifications may be made to adapt a particular situation or material to the teaching of the present invention without departing from the central scope thereof. Therefore, it is intended that the present invention not be limited to the particular embodiment disclosed as the best mode contemplated for carrying out the present invention, but that the present invention includes all embodiments falling within the scope of the appended claims.

The foregoing description and the drawings are regarded by the applicant as including a variety of individually inventive concepts, some of which may lie partially or wholly outside the scope of some or all of the following claims. The fact that the applicant has chosen at the time of filing of the present application to restrict the claimed scope of protection in accordance with the following claims is not to be taken as a disclaimer or alternative inventive concepts that are included in the contents of the application and could be defined by claims differing in scope from the following claims, which different claims may be adopted subsequently during prosecution, for example, for the purposes of a divisional application.

What is claimed is:

1. An image projection display device, comprising:
an image signal source for providing plural sorts of primary color signals;
a light source comprising a plural sort of light emitting devices respectively emitting monochromatic lights corresponding to the primary color signals;
a first optical system for guiding the monochromatic lights output from the light source;
a DMD having a plurality of two-dimensionally arrayed micro-mirrors, provided for receiving the monochromatic lights guided through first optical system;
a controller receiving the primary color signals from the image signal source for controlling the DMD so that specific micro-mirrors on the DMD change their own orientations by being activated with the primary color signals sequentially supplied from the image signal source and the light source so that the respective monochromatic lights are sequentially emitted in synchronous with the primary color signals; and
a second optical system for sequentially projecting respective primary color image patterns presented by the specific orientation-changed micro-mirrors on the DMD in a prescribed direction.

2. An image projection display device as claimed in claim 1, wherein the light source comprises one or more sets of a red-light emitting device, a green-light emitting device, and a blue-light emitting device as the plural sort of light emitting devices.

3. An image projection display device as claimed in any one of claims 1 and 2, wherein the controller adjusts the quantities of the respective emitted monochromatic lights by controlling the operation times of the respective light emitting device.
